(19) United States
(12) Patent Application Publication
(10) Pub. No.: US 2017/0364786 A1
(43) Pub. Date: Dec. 21, 2017

(54) MONITORING DEVICE, MONITORING SYSTEM, AND NON-TRANSITORY COMPUTER-READABLE STORAGE MEDIUM

(71) Applicant: FUJITSU LIMITED, Kawasaki-shi (JP)

(72) Inventor: KOHEI HONDA, Kawasaki (JP)

(73) Assignee: FUJITSU LIMITED, Kawasaki-shi (JP)

(21) Appl. No.: 15/616,559

(22) Filed: Jun. 7, 2017

(30) Foreign Application Priority Data
Jun. 20, 2016 (JP) 2016-121913

(51) Int. Cl. G06K 19/07; G06K 19/077

(52) U.S. Cl. CPC G06K 19/0723; G06K 19/0776

(57) ABSTRACT

A rack monitoring device including a memory, and a processor coupled to the memory and the processor configured to obtain a first tag information on a tag stuck associated with a rack and a second tag information on a tag stuck associated with the device, determine whether or not a position of the device in the rack has been changed based on the first tag information and the second tag information, execute an update of reference image information when it is determined that the position of device in the rack has been changed, the reference image information corresponding to a specified state of a device mounted in the rack, execute monitoring of state of the rack based on the updated reference image information.

### CROSS-REFERENCE TO RELATED APPLICATION

This application is based upon and claims the benefit of priority of the prior Japanese Patent Application No. 2016-121913, filed on Jun. 20, 2016, the entire contents of which are incorporated herein by reference.

### FIELD

The embodiment discussed herein is related to a monitoring device, a monitoring system, and a non-transitory computer-readable storage medium.

### BACKGROUND

There is a technique for monitoring devices such as servers, storage and the like installed in a rack by using optical fibers to gather, at a location within the rack, light emitted by LEDs of the devices, acquiring an image of the gathered displayed light emitted by the LEDs by a camera, and displaying the acquired image on a personal computer. In addition, there is a technique for storing, as a normal image, an image displayed by LEDs in a case where a device normally operates, determining that an abnormality occurs in the device if an image different from the normal image is monitored, and notifying an administrator of the abnormality.

There is a stocker control system for managing stock and managing reception and delivery of objects using a system for simultaneously identifying symbols formed on shelves and stored objects in the reception and delivery of objects in and from a stocker having the shelves for storing objects.

In addition, there is a technique for reading contactless IC tags of rack-mount devices installed in a rack housing in which reader devices are installed on shelves of the rack housing, acquiring information on the rack-mount devices installed in the rack housing and information on the positions of the rack-mount devices in the rack housing, and achieving accurate configuration management of the rack housing.

Examples of related art are Japanese Laid-open Patent Publication Nos. 62-235101 and 2007-226582.

### SUMMARY

According to an aspect of the invention, a rack monitoring device including a memory, and a processor coupled to the memory and the processor configured to obtain a first tag information on a tag stuck associated with a rack and a second tag information on a tag stuck associated with the device, determine whether or not a position of the device in the rack has been changed based on the first tag information and the second tag information, execute an update of reference image information when it is determined that the position of device in the rack has been changed, the reference image information corresponding to a specified state of a device mounted in the rack, execute monitoring of state of the rack based on the updated reference image information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of an LED monitoring system;

FIG. 2A is a diagram illustrating an example of the arrangement of output ends of optical fibers on an output terminal installation board;

FIG. 2B is a diagram illustrating an example of an image of the output ends of the optical fibers;

FIG. 3 is a diagram illustrating the configuration of an LED monitoring system configured to automatically update a normal image;

FIG. 4 is a diagram illustrating barcodes attached to a rack;

FIG. 5 is a diagram illustrating an example of information recorded in a barcode;

FIG. 6 is a diagram illustrating a barcode attached to a device to be monitored;

FIG. 7 is a diagram illustrating an example of information recorded in a barcode;

FIG. 8 is a diagram illustrating a functional configuration of an adapter having sensor units;

FIG. 9 is a diagram illustrating an example of a management information storage section;

FIG. 10 is a diagram illustrating a functional configuration of a rack monitoring device;

FIG. 11 is a diagram illustrating an example of a rack information storage section;

FIG. 12A is a first flowchart indicating the flow of a process to be executed when the device to be monitored is installed;

FIG. 12B is a second flowchart indicating the flow of the process to be executed when the device to be monitored is installed;

FIG. 13 is a flowchart indicating the flow of a process to be executed when the device to be monitored is removed; and

FIG. 14 is a diagram illustrating a hardware configuration of a computer configured to execute a rack monitoring program according to an embodiment.

### DESCRIPTION OF EMBODIMENT

In a technique for determining that an abnormality occurs in a device in a case where an image different from a normal image is monitored, if the device installed in a rack is replaced or another device is added to the rack, the normal image is to be updated. This is due to the fact that, if the device is replaced or the other device is added, display states of LEDs are changed and the normal image is changed.

According to an aspect, an object of the present disclosure is to automatically update a normal image.

Hereinafter, an embodiment of a rack monitoring device disclosed herein, a light display unit monitoring system disclosed herein, and a rack monitoring program disclosed herein is described in detail. The embodiment does not limit techniques disclosed herein.

### Embodiment

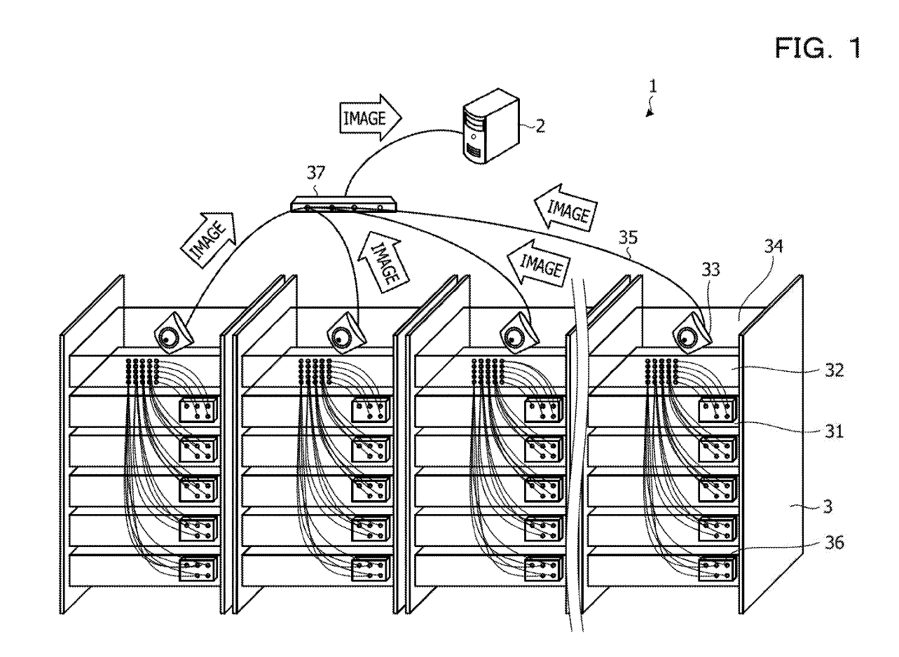

First, an LED monitoring system is described. Although LEDs are used in the embodiment, light display units such as organic electroluminescence (EL) lamps or light emitting displays may be used instead of the LEDs in the embodiment. FIG. 1 is a diagram illustrating the configuration of the LED monitoring system. As illustrated in FIG. 1, the LED monitoring system 1 includes an LED monitoring device 2, a plurality of devices 31 installed in each of a plurality of racks 3 and to be monitored, a plurality of camera units 34, and a switching hub 37. The number of the racks 3 is equal to the number of the camera units 34.

Five devices 31 to be monitored are installed in each of the racks 3 in FIG. 1, but devices 31 whose number is smaller or larger than five may be installed in each of the racks 3. The switching hub 37 may be a device for relaying in a network or may be a repeater hub or the like.

The LED monitoring device 2 monitors the devices 31 by monitoring lighting states of LEDs associated with the devices 31 to be monitored. The devices 31 are to be monitored by the LED monitoring device 2 and are servers, storage, or the like installed in a data center, for example.

The camera units 34 acquire video images indicating light emission states of light display units such as the LEDs and transmit the video images to the LED monitoring device 2 via the switching hub 37. Each of the camera units 34 includes an output end installation board 32 and a camera 33. On each of the output end installation boards 32, output ends of optical fibers 36 for gathering light emitted from LEDs of devices 31 to be monitored are arranged in a matrix. Other ends of the optical fibers 36 are light-receiving ends.

The cameras 33 acquire images of the output ends densely installed on the output end installation boards 32 and transmit the acquired images to the LED monitoring device 2 via local area network (LAN) cables 35 and the switching hub 37. The images of the output ends densely installed on the output end installation boards 32 indicate light emission states of the light display units such as the LEDs. The light emission states include luminance, hues, and the like of the light output by the LEDs. Radio channels may be used instead of the LAN cables 35.

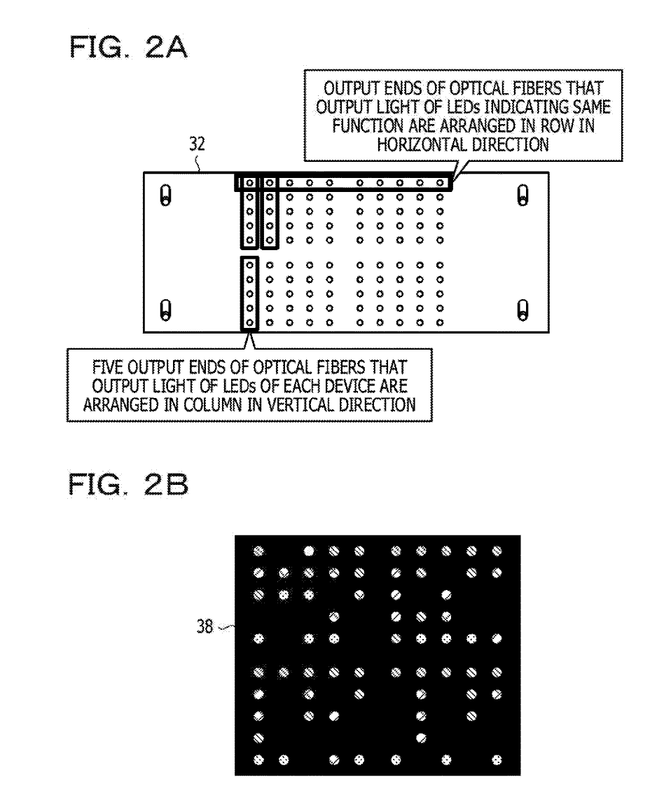

FIG. 2A is a diagram illustrating an example of the arrangement of output ends of optical fibers 36 on an output end installation board 32, while FIG. 2B is a diagram illustrating an example of an acquired image of the output ends. As illustrated in FIG. 2A, five output ends of optical fibers 36 that output light of LEDs of each device 31 to be monitored are arranged in a column in a vertical direction.

Output ends of optical fibers 36 that output light of LEDs indicating the same function are arranged in the same row in a horizontal direction. Functions indicated by the LEDs are a “power supply”, a “network link”, a “network act”, a “hard disk drive (HDD) access”, an “HDD fault”, a “section fault”, “maintenance”, a “customer self-service (CSS)”, a “power supply unit”, an “ID”, and the like. The horizontal arrangement and vertical arrangement of the acquired image are not limited to the embodiment and may be arbitrarily defined.

As illustrated in FIG. 2B, the acquired image 38 indicates lighting states of the LEDs. Although FIG. 2B illustrates the image in black and white, the actual image is a color image. In FIG. 2B, differences between patterns of circles indicate differences between colors. In the actual image, differences between luminance are expressed. FIG. 2B describes an example of the color image. The image, however, may be a monochrome image if changes in colors are not to be determined.

The LED monitoring device 2 stores a normal image (standard image for comparison) acquired when the devices 31 to be monitored are in normal states. Then, the LED monitoring device 2 compares most recently acquired images 38 with the normal image and determines whether or not an abnormality exists in the devices 31 to be monitored. Then, the LED monitoring device 2 displays results of the determination on a display device.

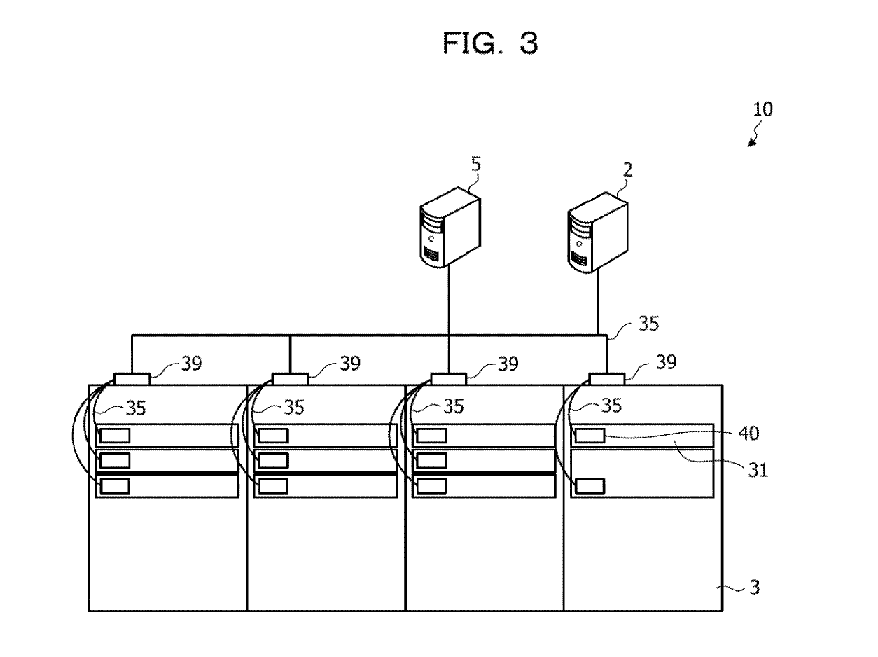

Next, the configuration of an LED monitoring system configured to automatically update the normal image is described. FIG. 3 is a diagram illustrating the configuration of the LED monitoring system configured to automatically update the normal image. As illustrated in FIG. 3, the LED monitoring system 10 configured to automatically update the normal image includes the LED monitoring device 2, the racks 3, a rack monitoring device 5, the devices 31 to be monitored, a switching hub 39, and adapters 40 having sensor units. The LED monitoring device 2, the rack monitoring device 5, the switching hub 39, and the adapters 40 having the sensor units are connected to each other via LAN cables 35. The LED monitoring system 10 also includes the camera units 34, the switching hub 37, and the like that are not illustrated in FIG. 3 and are included in the LED monitoring system 1 illustrated in FIG. 1.

The rack monitoring device 5 monitors an increase or reduction in the number of devices 31 included in the racks 3 and to be monitored and determines whether or not the normal image is to be updated. If the rack monitoring device 5 determines that the normal image is to be updated, the rack monitoring device 5 instructs the LED monitoring device 2 to update the normal image. The LED monitoring device 2 acquires a normal image based on the instruction from the rack monitoring device 5 and stores the acquired normal image. Details of the rack monitoring device 5 are described later.

The switching hub 39 relays communication between the adapters 40 having the sensor units and the rack monitoring device 5. The switching hub 39 may be the same as the switching hub 37 illustrated in FIG. 1.

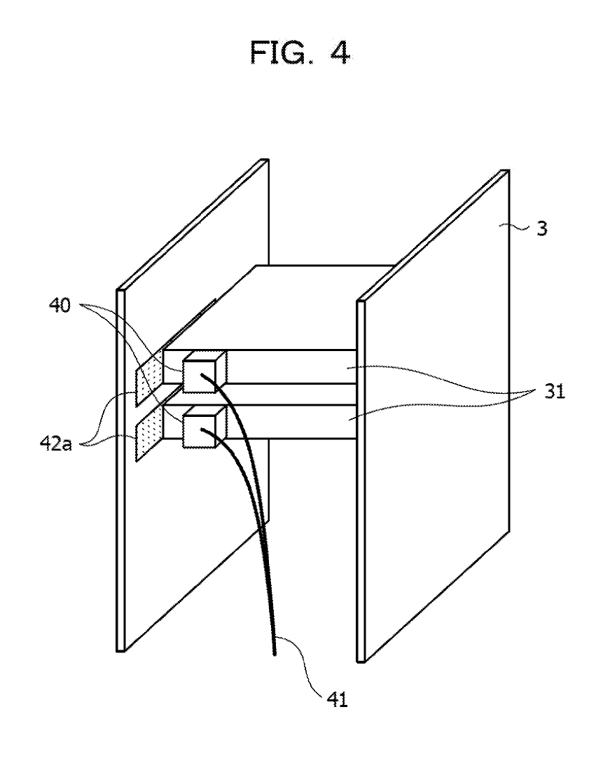

Each of the adapters 40 has two sensor units for reading barcodes. As illustrated in FIG. 4, the adapters 40 are fixed between the devices 31 to be monitored and power cables 41. The adapters 40 having the sensor units read barcodes attached to the racks 3 and barcodes attached to the devices 31 to be monitored.

FIG. 4 is a diagram illustrating barcodes 42a attached to a rack 3. As illustrated in FIG. 4, the barcodes 42a are attached for vertical positions of units of the rack 3 on a side surface of the rack 3 on the back side of the rack 3, respectively. In the barcodes 42a, a rack ID identifying the rack 3 and positional information indicating the vertical positions of the rack 3 are recorded.

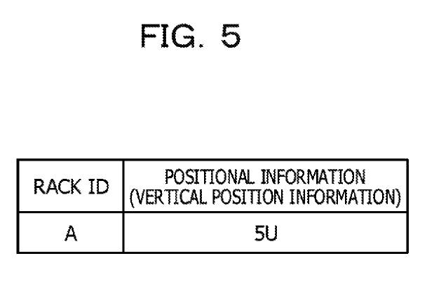

FIG. 5 is a diagram illustrating an example of information recorded in a barcode 42a. As illustrated in FIG. 5, “A” is recorded as a rack ID, and “5U” is recorded as positional information. “5U” indicates the fifth unit from the bottom of the rack 3. The adapters 40 having the sensor units read rack IDs and positional information from barcodes 42a and store the read rack IDs and the read positional information.

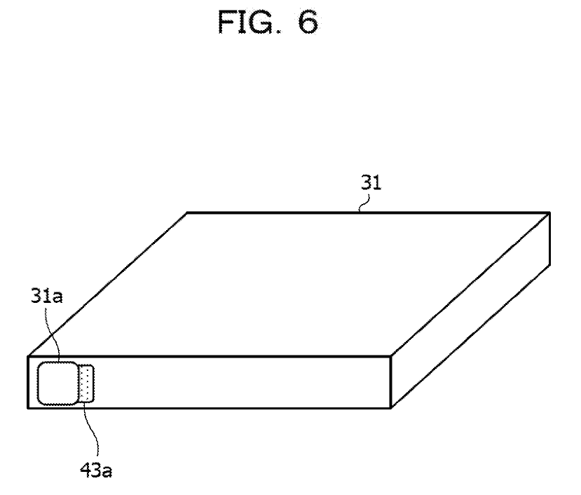

FIG. 6 is a diagram illustrating a barcode 43a attached to a device 31 to be monitored. As illustrated in FIG. 6, the barcode 43a is attached near a power cable insertion port 31a. In the barcode 43a, a device ID identifying the device 31 to be monitored is recorded.

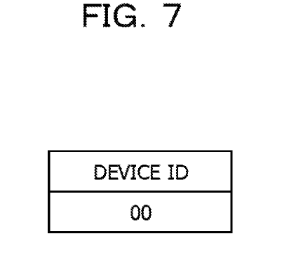

FIG. 7 is a diagram illustrating an example of the information recorded in the barcode 43a. As illustrated in FIG. 7, “00” is recorded as a device ID. The adapters 40 having the sensor units read device IDs from barcodes 43a and store the read device IDs. Although the embodiment describes the case where the barcodes are used, other codes such as QR codes (registered trademark) may be used instead of the barcodes in the embodiment.

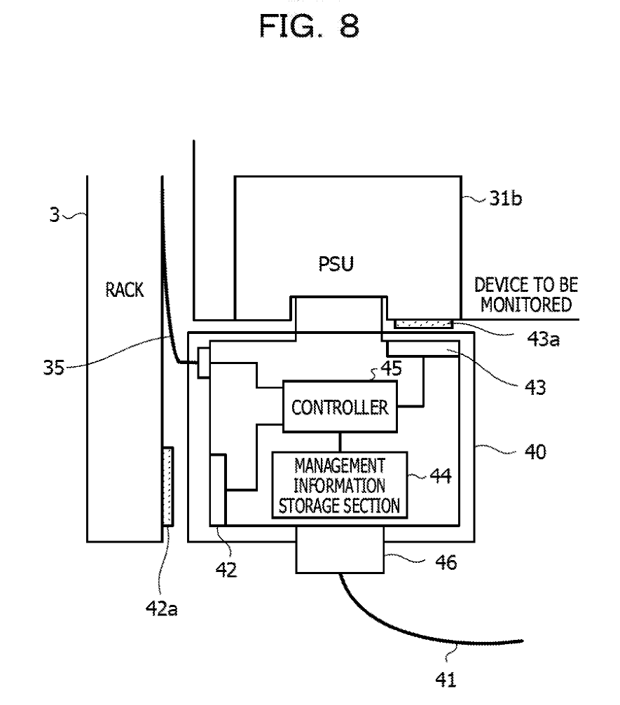

FIG. 8 is a diagram illustrating a hardware configuration of an adapter 40 having sensor units. The adapter 40 includes the sensor units 42 and 43, a management information storage section 44, and a controller 45. The adapter 40 having the sensor units has a specific adapter ID. The adapter 40 having the sensor units is connected to the rack monitoring device 5 via a LAN cable 35 and the switching hub 39. The adapter 40 having the sensor units is installed and fixed between a power supply unit (PSU) 31b and a power cable connector 46.

The sensor unit 42 reads a rack ID and positional information from a barcode 42a attached to a rack 3. The sensor unit 43 reads a device ID from a barcode 43a attached to a device 31 to be monitored.

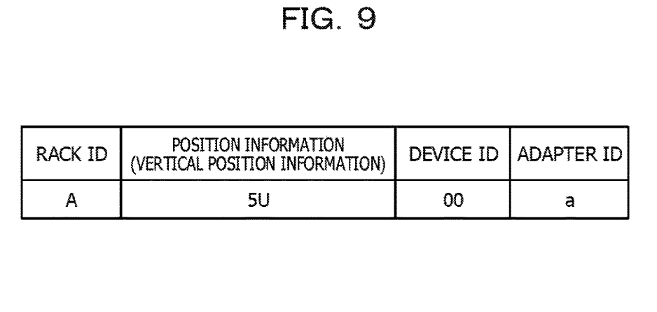

The management information storage section 44 stores, as rack information, the rack ID, the positional information, the device ID, and the adapter ID that are associated with each other. FIG. 9 is a diagram illustrating an example of the management information storage section 44. As illustrated in FIG. 9, the management information storage section 44 stores “A” as the rack ID, “5U” as the positional information, “00” as the device ID, and “a” as the adapter ID.

The rack ID and the positional information are read by the sensor unit 42 from the barcode 42a and written by the controller 45 in the management information storage section 44. The device ID is read by the sensor unit 43 from the barcode 43a and written by the controller 45 in the management information storage section 44.

The controller 45 writes, in the management information storage section 44, the rack ID and positional information read by the sensor unit 42 from the barcode 42a and the device ID read by the sensor unit 43 from the barcode 43a. The controller 45 transmits, as rack information, the rack ID, positional information, and device ID written in the management information storage section 44 and the adapter ID to the rack monitoring device 5.

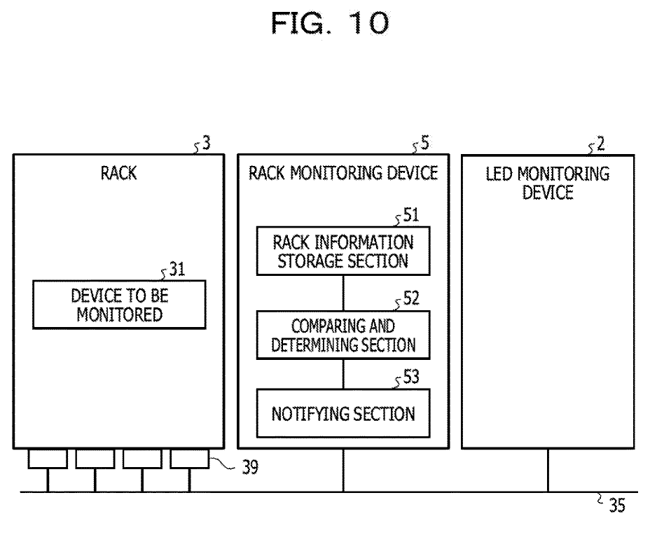

Next, a functional configuration of the rack monitoring device 5 is described. FIG. 10 is a diagram illustrating the functional configuration of the rack monitoring device 5. As illustrated in FIG. 10, the rack monitoring device 5 includes a rack information storage section 51, a comparing and determining section 52, and a notifying section 53.

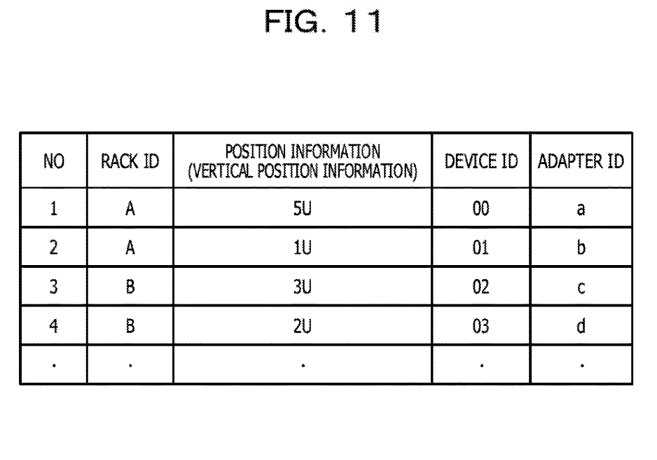

The rack information storage section 51 stores information on the devices installed in the racks 3. FIG. 11 is a diagram illustrating an example of the rack information storage section 51. As illustrated in FIG. 11, the rack information storage section 51 stores numbers (Nos), rack IDs, positional information, device IDs, and adapter IDs that are associated with each other. Specifically, the rack information storage section 51 stores the information obtained by adding the numbers to rack information transmitted by the adapters 40 having the sensor units.

The numbers are serial numbers added to entries. For example, in an entry in which a number is “1”, a rack ID is “A”, positional information is “5U”, a device ID is “00”, and an adapter ID is “a”.

When receiving rack information from an adapter 40 having sensor units, the comparing and determining section 52 instructs the notifying section 53 to instruct the LED monitoring device 2 to stop the monitoring. Then, the comparing and determining section 52 compares the received rack information with the rack information indicated in the entries of the rack information storage section 51 and determines whether or not the received rack information is already stored in the rack information storage section 51.

If the received rack information is already stored in the rack information storage section 51, a new device 31 to be monitored is not installed and the comparing and determining section 52 instructs the notifying section 53 to instruct the LED monitoring device 2 to restart the monitoring.

On the other hand, if the received rack information is not stored in the rack information storage section 51, the comparing and determining section 52 writes the received information as a new entry in the rack information storage section 51 and instructs the notifying section 53 to instruct the LED monitoring device 2 to update the normal image. Then, when receiving a notification indicating the completion of the update of the normal image from the LED monitoring device 2 via the notifying section 53, the comparing and determining section 52 instructs the notifying section 53 to instruct the LED monitoring device 2 to restart the monitoring.

In addition, the comparing and determining section 52 detects turning-off of a power supply of an adapter 40 having sensor units and instructs the notifying section 53 to instruct the LED monitoring device 2 to stop the monitoring. If the comparing and determining section 52 does not receive rack information within a certain time period, the comparing and determining section 52 determines that a device 31 to be monitored has been removed from a rack 3 and the comparing and determining section 52 deletes, from the rack information storage section 51, information on the removed device 31 to be monitored. Then, the comparing and determining section 52 instructs the notifying section 53 to instruct the LED monitoring section 2 to update the normal image. Then, when receiving a notification indicating the completion of the update of the normal image from the LED monitoring device 2 via the notifying section 53, the comparing and determining section 52 instructs the notifying section 53 to instruct the LED monitoring device 2 to restart the monitoring.

On the other hand, if the comparing and determining section 52 receives the rack information within the certain time period, the comparing and determining section 52 determines whether or not the removed device 31 to be monitored has been returned to the rack 3. If the comparing and determining section 52 determines that the removed device 31 to be monitored has been returned to the rack 3, the comparing and determining section 52 instructs the notifying section 53 to instruct the LED monitoring device 2 to restart the monitoring. If the removed device 31 to be monitored has not been returned and a new device 31 to be monitored has been added to the rack 3, the comparing and determining section 52 deletes, from the rack information storage section 51, information on the removed device 31 to be monitored and instructs the notifying section 53 to instruct the LED monitoring device 2 to update the normal image. Then, when receiving a notification indicating the completion of the update of the normal image from the LED monitoring device 2 via the notifying section 53, the comparing and determining section 52 instructs the notifying section 53 to instruct the LED monitoring device 2 to restart the monitoring.

The notifying section 53 instructs, based on instructions from the comparing and determining section 52, the LED monitoring device 2 to stop and restart the monitoring, update the image, and the like. When receiving a notification indicating the completion of the update of the normal image from the LED monitoring device 2, the notifying section 53 notifies the comparing and determining section 52 of the completion of the update of the normal image.

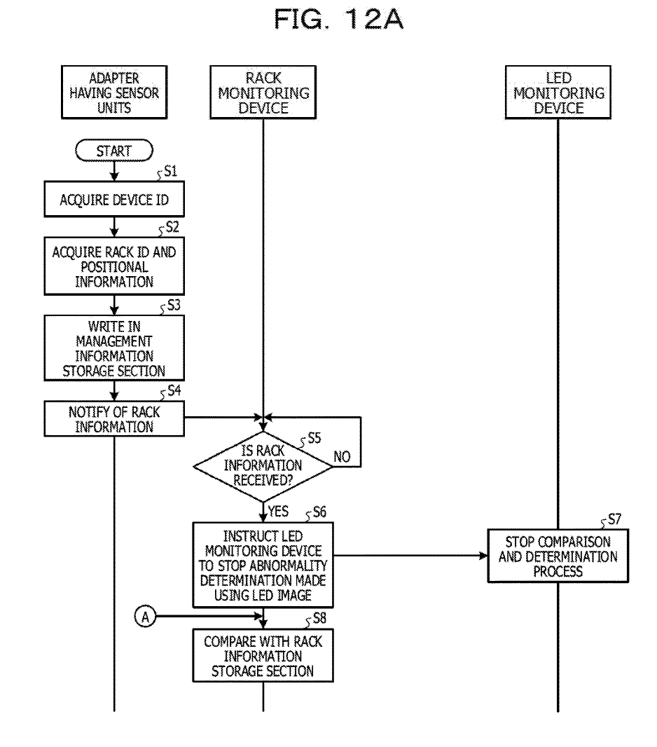

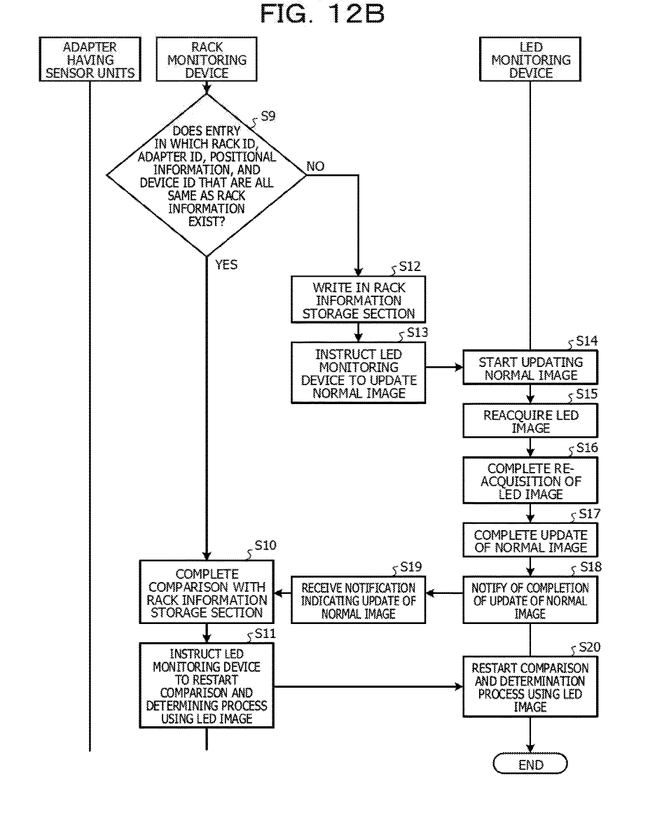

Next, the flow of a process to be executed when a device 31 to be monitored is installed is described. FIGS. 12A and 12B are flowcharts indicating the flow of the process to be executed when a device 31 to be monitored is installed. As illustrated in FIG. 12A, when a power supply of the device 31 to be monitored is turned on, an adapter 40 having sensor units and fixed to the installed device 31 to be monitored reads a barcode 43a and acquires a device ID from the barcode 43a (in step S1).

Then, the adapter 40 having the sensor units reads a barcode 42a and acquires a rack ID and positional information from the barcode 42a (in step S2). The adapter 40 having the sensor units associates the device ID, the rack ID, and the positional information with an adapter ID of the adapter 40 and writes, as rack information, the device ID, the rack ID, the positional information, and the adapter ID in the management information storage section 44 (in step S3). The adapter 40 having the sensor units notifies the rack monitoring device 5 of the rack information (in step S4).

The rack monitoring device 5 determines whether or not the rack monitoring device 5 has received the rack information (in step S5). When receiving the rack information, the rack monitoring device 5 instructs the LED monitoring device 2 to stop abnormality determination made using an LED image (in step S6). Then, the LED monitoring device 2 compares the acquired LED image with the normal image and stops a comparison and determination process of determining an abnormality (in step S7).

Then, the rack monitoring device 5 executes a process of comparing the received rack information with the rack information storage section 51 (in step S8). Specifically, the rack monitoring device 5 determines whether or not an entry that includes a rack ID, an adapter ID, positional information, and a device ID that are all the same as the received rack information exists in the rack information storage section 51 (in step S9).

If the entry exists in the rack information storage section 51 as a result of the determination, the rack monitoring device 5 completes the comparison with the rack information storage section 51 (in step S10) and instructs the LED monitoring device 2 to restart the comparison and determination process using an LED image (in step S11). When receiving the instruction, the LED monitoring device 2 restarts the comparison and determination process using the LED image (in step S20).

On the other hand, if the entry that includes the rack ID, the adapter ID, the positional information, and the device ID that are all the same as the received rack information does not exist in the rack information storage section 51, the rack monitoring device 5 writes the received rack information in the rack information storage section 51 (in step S12). If the rack monitoring device 5 determines that the rack information has been received in step S44 (described later), the process returns to step S8 and proceeds to S12, the rack monitoring device 5 deletes, from the rack information storage section 51, rack information on the removed device 31 to be monitored. Then, the rack monitoring device 5 instructs the LED monitoring device 2 to update the normal image (in step S13).

The LED monitoring device 2 receives the instruction, starts updating the normal image (in step S14), and reacquires an LED image (in step S15). Then, the LED monitoring device 2 completes the re-acquisition of the LED image (in step S16) and completes the update of the normal image (in step S17). Then, the LED monitoring device 2 notifies the rack monitoring device 5 of the completion of the update of the normal image (in step S18).

The rack monitoring device 5 receives the notification indicating the completion of the normal image (in step S19), completes the comparison with the rack information storage section 51 (in step S10), and instructs the LED monitoring device 2 to restart the comparison and determination process using an LED image (in step S11). When receiving the instruction, the LED monitoring device 2 restarts the comparison and determination process using the LED image (in step S20).

As described above, when a new device 31 to be monitored is installed in a rack 3, the rack monitoring device 5 instructs the LED monitoring device 2 to update the normal image, and the LED monitoring device 2 may execute the monitoring using a proper normal image.

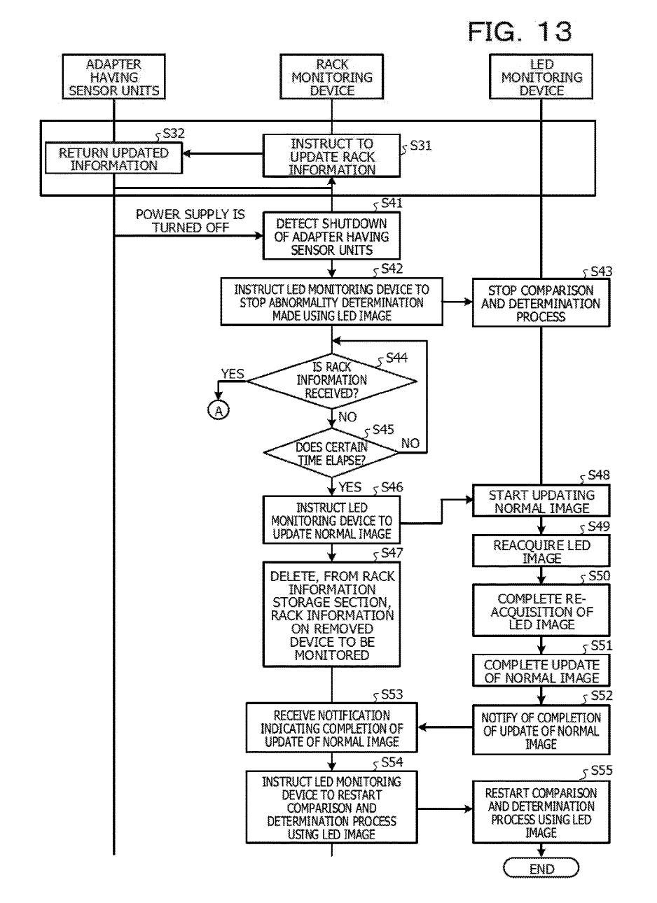

Next, the flow of a process to be executed when a device 31 to be monitored is removed. FIG. 13 is a flowchart indicating the flow of the process to be executed when a device 31 to be monitored is removed. As illustrated in FIG. 13, the rack monitoring device 5 instructs an adapter 40 having sensor units to update rack information at regular intervals (in step S31). The adapter 40 having the sensor units updates information stored in the management information storage sections 44 and returns the updated information to the rack monitoring device 5 (in step S32). The rack monitoring device 5 receives the updated information. If the updated information matches information stored in the rack information storage section 51, the rack monitoring device 5 does not execute any operation. The regular intervals are, for example, 5 seconds.

When a power supply of the device 31 to be monitored is turned off by an operation administrator or a maintenance person in order to remove the device 31 to be monitored, a power supply of the adapter 40 having the sensor units is turned off. Then, the rack monitoring device 5 detects the shutdown of the adapter 40 having the sensor units (in step S41) and instructs the LED monitoring device 2 to stop the abnormality determination made using an LED image (in step S42). The LED monitoring device 2 compares the acquired LED image with the normal image and stops the comparison and determination process of determining an abnormality (in step S43).

Then, the rack monitoring device 5 determines whether or not the rack monitoring device 5 has received rack information (in step S44). If the rack monitoring device 5 has received the rack information, the process proceeds to step S8 illustrated in FIG. 12A and the rack monitoring device 5 determines whether or not the removed device 31 to be monitored has been returned to the original position of the device 31 to be monitored. If the rack monitoring device 5 has not received the rack information, the rack monitoring device 5 determines whether or not a certain time has elapsed (in step S45). If the certain time has not elapsed, the process returns to step S44.

If the certain time has elapsed, the rack monitoring device 5 determines that the device 31 to be monitored has been removed, and the rack monitoring device 5 instructs the LED monitoring device 2 to update the normal image (in step S46). Then, the rack monitoring device 5 deletes, from the rack information storage section 51, rack information on the removed device 31 to be monitored (in step S47).

The LED monitoring device 2 receives the instruction to update the normal image, starts updating the normal image (in step S48), and reacquires an LED image (in step S49). Then, the LED monitoring device 2 completes the re-acquisition of the LED image (in step S50) and completes the update of the normal image (in step S51). Then, the LED monitoring device 2 notifies the rack monitoring device 5 of the completion of the update of the normal image (in step S52).

Then, the rack monitoring device 5 receives the notification indicating the completion of the update of the normal image (in step S53) and instructs the LED monitoring device 2 to restart the comparison and determination process using an LED image (in step S54). The LED monitoring device 2 receives the instruction and restarts the comparison and determination process using the LED image (in step S55).

As described above, when a device 31 to be monitored is removed from a rack 3, the rack monitoring device 5 instructs the LED monitoring device 2 to update the normal image, and the LED monitoring device 2 may execute the monitoring using a proper normal image.

As described above, in the embodiment, the comparing and determining section 52 of the rack monitoring device 5 determines whether or not the devices 31 installed in the racks 3 and to be monitored have been changed. If the comparing and determining section 52 determines that a device 31 to be monitored has been changed, the comparing and determining section 52 instructs the notifying section 53 to instruct the LED monitoring device 2 to update the normal image. Then, the notifying section 53 instructs, based on the instruction from the comparing and determining section 52, the LED monitoring device 2 to update the normal image. Thus, the LED monitoring device 2 may automatically update the normal image.

In the embodiment, the comparing and determining section 52 determines, based on the device IDs, the rack IDs, and the positional information, whether or not the devices 31 installed in the racks 3 and to be monitored have been changed. Thus, the comparing and determining section 52 may accurately determine whether or not the devices 31 installed in the racks 3 and to be monitored have been changed.

In the embodiment, the adapters 40 having the sensor units are installed between PSUs 31b of the devices 31 to be monitored and power cable connectors 46. Thus, the adapters 40 having the sensor units acquire the device IDs from the devices 31 to be monitored and acquire the rack IDs and the positional information from the racks 3.

In the embodiment, the adapters 40 having the sensor units read the device IDs from barcodes 43a attached to the devices 31 to be monitored and read the rack IDs and the positional information from barcodes 42a attached to the racks 3. Thus, the adapters 40 having the sensor units easily acquire the device IDs, the rack IDs and the positional information.

In the embodiment, the comparing and determining section 52 determines whether or not a device 31 removed from a rack 3 and to be monitored has been returned to the original position of the device 31 to be monitored. If the comparing and determining section 52 determines that the removed device 31 to be monitored has been returned to the original position, the comparing and determining section 52 determines that the device 3 installed in the rack 3 and to be monitored has not been changed. Thus, the rack monitoring device 5 may inhibit the LED monitoring device 2 from excessively updating the normal image.

The embodiment describes the rack monitoring device 5, but a rack monitoring program that has the same functions as those included in the rack monitoring device 5 may be achieved by causing software to achieve the functions included in the rack monitoring device 5. A computer configured to execute the rack monitoring program is described below.

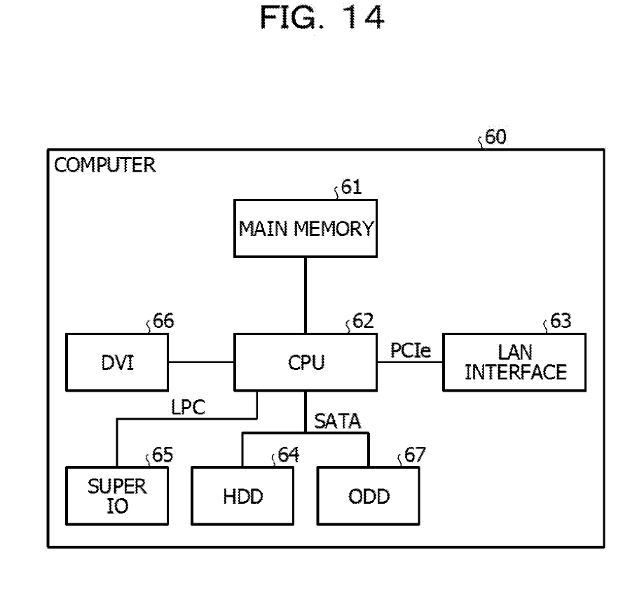

FIG. 14 is a diagram illustrating a hardware configuration of the computer configured to execute the rack monitoring program according to the embodiment. As illustrated in FIG. 14, the computer 60 includes a main memory 61, a CPU 62, a LAN interface 63, and a hard disk drive (HDD) 64. The computer 60 also includes a super input output (10) 65, a digital visual interface (DVI) 66, and an optical disc drive (ODD) 67.

The main memory 61 stores the program, intermediate results of executing the program, and the like. The CPU 62 is a central processing unit configured to read the program from the main memory 61 and execute the program. The CPU 62 includes a chip set having a memory controller.

The LAN interface 63 is configured to connect the computer 60 to another computer via a LAN. The HDD 64 is a disk device configured to store the program and data. The super IO 65 is an interface configured to connect the computer 60 to input devices such as a mouse and a keyboard. The DVI 66 connects the computer 60 to a liquid crystal display device. The ODD 67 is a device configured to execute reading and writing from and in a DVD.

The LAN interface 63 is connected to the CPU 62 by PCI Express (PCIe). The HDD 64 and the ODD 67 are connected to the CPU 62 by Serial Advanced Technology Attachment (SATA). The super IO 65 is connected to the CPU 62 by Low Pin Count (LPC).

The rack monitoring program to be executed by the computer 60 is stored in the DVD, read by the ODD 67 from the DVD, and installed in the computer 60. Alternatively, the rack monitoring program is stored in a database of another computer system connected to the computer 60 via the LAN interface 63, read from the database, and installed in the computer 60. The installed rack monitoring program is stored in the HDD 64, read into the main memory 61, and executed by the computer 62.

The embodiment describes the case where the rack monitoring device 5 instructs the LED monitoring device 2 to update the normal image every time a new device 31 to be monitored is installed in a rack 3. However, if a plurality of devices 31 to be monitored is installed in racks 3, the normal image is frequently updated.

The rack monitoring device 5 may collectively execute the process for rack information received within a predetermined time period and detected shutdown of adapters 40 having sensor units. If devices 31 to be monitored are removed and returned to the original positions of the devices 31 to be monitored, the rack monitoring device 5 may cancel the detection of shutdown of adapters 40 having sensor units and the reception of rack information and may not instruct the LED monitoring device 2 to update the normal image.

In this manner, the rack monitoring device 5 may collectively execute the process for the rack information received within the predetermined time period and the detected shutdown of the adapters 40 having the sensor units, thereby reducing the frequency at which the normal image is updated.

The embodiment describes the case where the rack monitoring device 5 is different from the LED monitoring device 2. The LED monitoring device 2, however, may include the functions of the rack monitoring device 5.

The embodiment describes the case where the racks 3 are monitored using the adapters 40 having the sensor units. The rack monitoring device 5, however, may use another method to monitor whether or not the devices 31 installed in the racks 3 and to be monitored have been changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A rack monitoring device comprising:
a memory; and
a processor coupled to the memory and the processor configured to:
obtain a first tag information on a tag stuck associated with a rack and a second tag information on a tag stuck associated with the device;
determine whether or not a position of the device in the rack has been changed based on the first tag information and the second tag information;
execute an update of reference image information when it is determined that the position of device in the rack has been changed, the reference image information corresponding to a specified state of a device mounted in the rack; and
execute monitoring of state of the rack based on the updated reference image information.

2. The rack monitoring device according to claim 1, wherein
the first tag information indicating a position within the rack.

3. The rack monitoring device according to claim 1, wherein
the first tag information and the second tag information are obtained by using an adapter mounted between a power supply of the device and a power cable connector, the adapter including a sensor configured to read the tag stuck associated with the rack and the tag stuck associated with the device.

4. The rack monitoring device according to claim 1, wherein the processor is configured to:
determine whether or not the device removed from the rack and to be monitored has been returned to the same position within the rack; and
determine that the device has not been changed when it is determined that the device removed from the rack and to be monitored has been returned to the same position, the determining section determines.

5. A monitoring system comprising:
an adapter mounted between a power supply of a device, mounted in a rack, to be monitored and a power cable connector, the adapter including:
a sensor configured to read a first tag information on a tag stuck associated with the rack and a second tag information on a tag stuck associated with the device;
a rack monitoring device including:
a first memory; and
a first processor coupled to the memory and the first processor configured to:
determine whether or not a position of the device in the rack has been changed based on the first tag information and the second tag information; and
execute an update of reference image information when it is determined that the position of device in the rack has been changed, the reference image information corresponding to a specified state of a device mounted in the rack; and
a light display monitoring device including:
a camera device configured to obtain an image inside of the rack;
a second memory that stores the updated reference image; and
a second processor coupled to the memory, the second processor being configured to monitor a state of the rack based on the updated reference image information and the obtained image.

6. A non-transitory computer-readable storage medium storing a monitoring program that causes a computer to execute a process, the process comprising:
obtaining a first tag information on a tag stuck associated with a rack and a second tag information on a tag stuck associated with the device;
determining whether or not a position of the device in the rack has been changed based on the first tag information and the second tag information;
executing an update of reference image information when it is determined that the position of device in the rack has been changed, the reference image information corresponding to a specified state of a device mounted in the rack; and
executing monitoring of state of the rack based on the updated reference image information.
